(19) United States
(12) Patent Application Publication
(10) Pub. No.: US 2010/0208076 A1
(43) Pub. Date: Aug. 19, 2010

(54) IMAGE RECORDING CONDITION SETTING APPARATUS, IMAGE RECORDING CONDITION SETTING METHOD, AND DRIVE RECORDER

(75) Inventor: Hiro Kinoshita, Kobe-shi (JP)

Correspondence Address: OLIFF & BERRIDGE, PLC, P.O. BOX 320850, ALEXANDRIA, VA, 22320-4850, US

(73) Assignee: Fujitsu Ten Limited, Kobe-shi, Hyogo (JP)

(21) Appl. No.: 12/734,031

(22) PCT Filed: Oct. 9, 2008
(86) PCT No.: PCT/JP2008/068813

§ 371 Date: Apr. 6, 2010

(30) Foreign Application Priority Data
Oct. 12, 2007 (JP) 2007-266952

(51) Int. Cl. H04N 7/18; G08G 1/123

(52) U.S. Cl. 348/148; 340/989; 348/E07.085

(57) ABSTRACT

An object of the invention is to provide an image recording condition setting apparatus, an image recording condition setting method, and a drive recorder that can always set an optimum recording condition in the drive recorder. In particular, the invention provides an image recording condition setting apparatus, an image recording condition setting method, and a drive recorder, wherein the apparatus includes a receiving unit for receiving vehicle driving condition information from the drive recorder, determining means for determining recording condition setting information based on the received vehicle driving condition information, and a transmitting unit for transmitting the recording condition setting information, determined by the determining means, to the drive recorder.

### FIELD OF THE INVENTION

The present invention relates to an image recording condition setting apparatus, an image recording condition setting method, and a drive recorder, and in particular to a condition setting apparatus and condition setting method for setting a recording condition for a drive recorder to record image information.

### BACKGROUND OF THE INVENTION

In the prior art, a vehicle-mounted image recording apparatus has been proposed, generally known as a vehicle drive recorder, that captures an image of the view outside a vehicle by a camera mounted on the vehicle and that records the captured image along with vehicle speed upon detecting an impact applied to the vehicle in such situations as a collision, hard braking, etc. When such a drive recorder is mounted in a vehicle, it becomes possible, in the event of a vehicle accident, to investigate the cause of the accident by analyzing the recorded information. Furthermore, when such a drive recorder is mounted in a vehicle, not only can the driver's awareness of safe driving be enhanced, but also the video that recorded the driver's driving habits can be utilized, for example, for safe driving guidance.

Patent documents 1 and 2 each disclose a drive recorder in which images being captured by a vehicle-mounted camera are recorded in a continuously looping fashion and, in the event of a vehicle accident, the recorded images are saved on another recording medium. Further, patent documents 3 and 4 each disclose a drive recorder in which vehicle driving data, such as vehicle speed and transmission gear position, is recorded in a continuously looping fashion, and in the event of a vehicle accident, the recorded driving data is saved on another recording medium.

Patent document 1: Japanese Unexamined Patent Publication No. S63-16785

Patent document 2: Japanese Unexamined Patent Publication No. H06-237463

Patent document 3: Japanese Unexamined Patent Publication No. H06-331391

Patent document 4: Japanese Unexamined Patent Publication No. H06-186061

### SUMMARY OF THE INVENTION

When recording image information on a drive recorder, it is common to set in advance a condition for recording. For example, one may set a condition for image information recording by connecting the drive recorder directly to a setup PC located at its base station or by connecting a recording medium used in the drive recorder to the setup PC. In any case, once the condition has been set, it is not possible to change the condition until the vehicle equipped with the drive recorder returns to its base station.

However, since the condition for the drive recorder to record image information varies depending on road conditions and driving conditions, it has been difficult to always record image information using an appropriate condition. This has led to the problem that when the threshold level is set high, for example, image information is recorded only when a severe accident occurs, and conversely, when the threshold level is set low, image information not worth recording is recorded too often for events that do not lead up to an accident.

Accordingly, it is an object of the present invention to provide an image recording condition setting apparatus, an image recording condition setting method, and a drive recorder that can always set an optimum recording condition in the drive recorder.

An image recording condition setting apparatus according to the invention includes a receiving unit for receiving vehicle driving condition information from a drive recorder, determining means for determining recording condition setting information based on the received vehicle driving condition information, and a transmitting unit for transmitting the recording condition setting information, determined by the determining means, to the drive recorder.

An image recording condition setting apparatus according to the invention includes a receiving unit for receiving vehicle position information from a drive recorder, a storage unit for storing map information including route type, determining means for acquiring, based on the position information and the map information, the route type of a route along which a vehicle is traveling, and for determining recording condition setting information corresponding to the route type; and a transmitting unit for transmitting the recording condition setting information, determined by the determining means, to the drive recorder in order to set a threshold value for a condition for the drive recorder to record an image.

An image recording condition setting method according to the invention includes the steps of receiving vehicle driving condition information from a drive recorder, determining recording condition setting information based on the received vehicle driving condition information, and transmitting the determined recording condition setting information to the drive recorder in order to set a threshold value for a condition for the drive recorder to record an image.

An image recording condition setting method according to the invention includes the steps of transmitting vehicle driving condition information to a setting apparatus, receiving from the setting apparatus recording condition setting information associated with the vehicle driving condition information, and setting the recording condition setting information as a threshold value for a condition for recording an image.

An image recording condition setting method according to the invention includes the steps of transmitting vehicle position information to a setting apparatus by a drive recorder, receiving the position information by the setting apparatus, determining recording condition setting information based on the position information by the setting apparatus, transmitting the recording condition setting information to the drive recorder by the setting apparatus, and setting the received recording condition setting information as a threshold value for a condition for the drive recorder to record an image by the drive recorder.

A drive recorder according to the invention includes an acquiring unit for acquiring vehicle driving condition information, and a setting unit for setting recording condition setting information, determined based on the vehicle driving condition information, as a threshold value for a condition for recording an image.

With the image recording condition setting apparatus, the image recording condition setting method, and the drive recorder according to the present invention, since the recording condition setting information is determined in accordance with the vehicle driving condition information and is set as the threshold value for the condition for the drive recorder to record an image, the image can always be recorded by an optimum condition.

### BRIEF DESCRIPTION OF THE DRAWINGS

FIG. 1 is a diagram showing an example in which a drive recorder is mounted in a vehicle.

FIG. 2 is a diagram schematically showing the configuration of an entire system.

FIG. 3 is a diagram showing one example of a process flow.

FIG. 4 is a diagram showing map information.

FIG. 5 is a diagram showing a table of recording condition setting information.

FIG. 6 is a diagram showing another map information.

FIG. 7 is a diagram schematically showing the configuration of another system.

### DETAILED DESCRIPTION OF THE PREFERRED EMBODIMENT

Embodiments of the present invention will be described in detail below with reference to the drawings. It should be noted, however, that the technical scope of the present invention is not limited to the specific embodiments described herein, but extends to the inventions described in the appended claims and their equivalents. It should also be noted that the present invention can be carried out in other ways by making various changes without departing from the spirit and scope of the invention.

First, an overview of image information recording in a drive recorder will be provided.

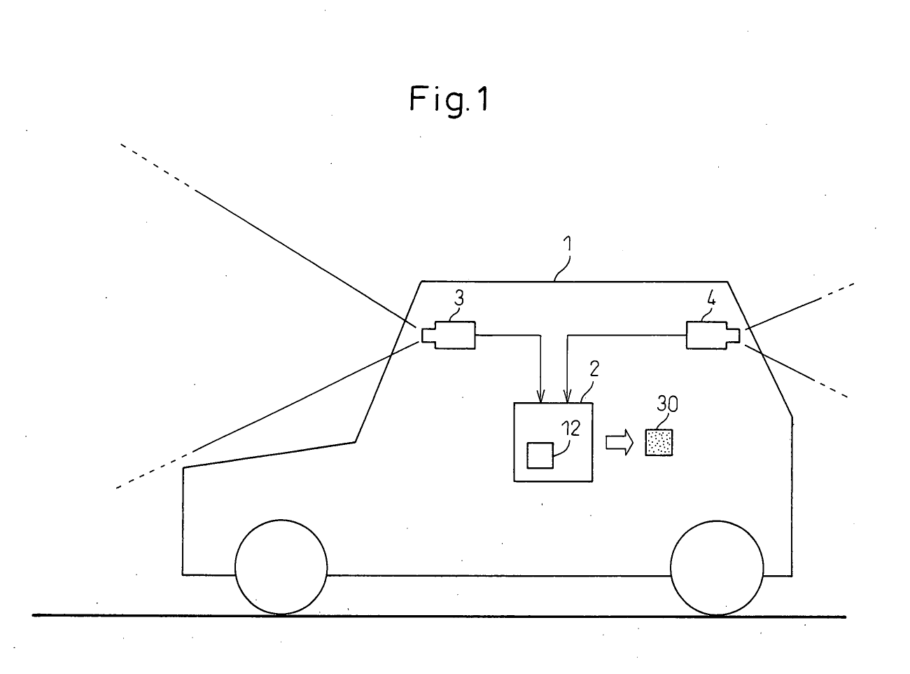

FIG. 1 is a diagram showing an example in which the drive recorder 2 is mounted in a vehicle 1.

The drive recorder 2 mounted in the vehicle 1 is connected to a video camera 3 for capturing the view ahead of the vehicle 1 and a video camera 4 for capturing the view behind the vehicle 1. Image information from the video cameras 3 and 4 is stored in a semiconductor storage unit 12 in a continuously looping fashion. When a predetermined recording condition holds, the image information stored in the semiconductor storage unit 12 is transferred for recording on a memory card 30. The image information recorded on the memory card 30 is transferred to a storage device 150 of a PC (personal computer) 110 located at a vehicle base station 100 by connecting the memory card 30 to the PC 110, and the image information is played back on the PC 110 for investigation, etc.

The predetermined recording condition here refers to an event that occurs, for example, when the vehicle 1 is subjected to an impact due to an accident or the like.

Some of such recording conditions are set as needed from the PC 110 located at the base station 100 in accordance with the vehicle driving conditions.

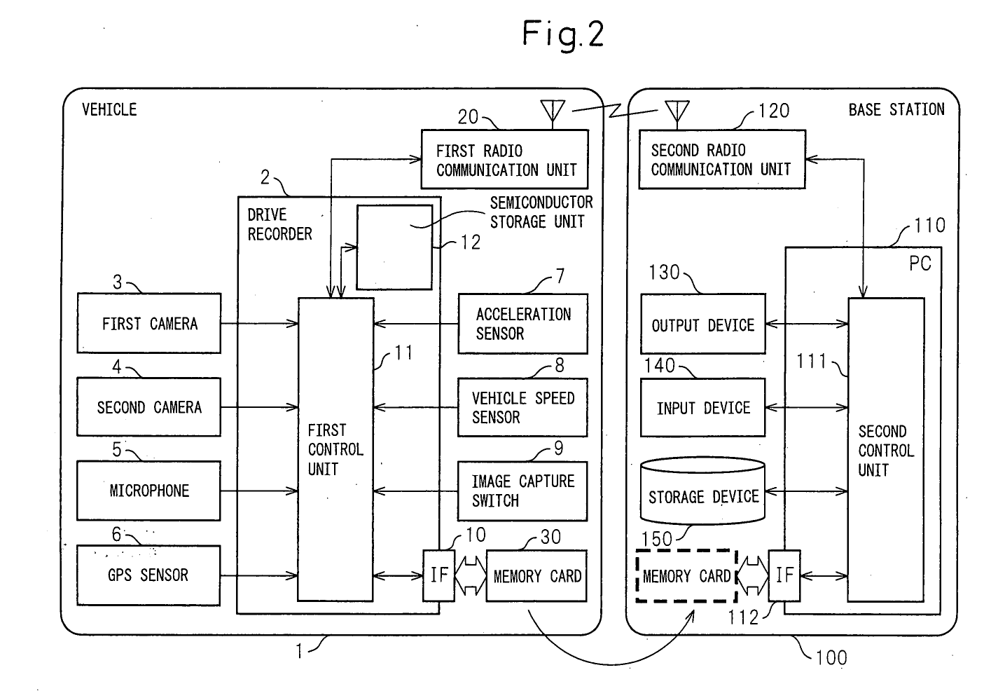

FIG. 2 is a diagram schematically showing the configuration of the entire system according to the present invention.

At the vehicle 1 side, there are provided, in addition to the drive recorder 2, the video camera 3 for capturing the view ahead of the vehicle 1, and the video camera 4 for capturing the view behind the vehicle 1, a microphone 5 for picking up sound from the surroundings, a GPS sensor 6, an acceleration sensor 7, a vehicle speed sensor 8, an image capture switch 9, an interface 10 to the memory 30, a radio communication unit 20, etc.

The drive recorder 2 comprises, in addition to the semiconductor storage unit 12, a first control unit 11 which includes a CPU, a RAM, and a ROM. However, the drive recorder 2 may be combined with the video cameras 3 and 4, microphone 5, GPS sensor 6, acceleration sensor 7, vehicle speed sensor 8, image capture switch 9, interface 10, and/or radio communication unit 20 in a single unit. Further, the function of the drive recorder 2 may be incorporated into a vehicle-mounted navigation system.

The video camera 3 is constructed, for example, from a two-dimensional image sensor such as a CCD (Charge Coupled Device) image sensor or a CMOS (Complementary Metal Oxide Semiconductor) image sensor, and is controlled so as to capture the view ahead of the vehicle 1 and to output it as first image information.

The video camera 4 is installed as an additional camera in the vehicle 1, and is controlled so as to capture the view behind the vehicle or a view in a direction different than the direction of the camera 3, for example, the view inside the passenger compartment, and to output it as second image information. If only one video camera suffices, there is no need to connect the video camera 4. Further, provisions may be made to use the video cameras 3 and 4 in an alternating fashion.

The microphone 5 is configured to pick up sound inside or outside the vehicle 1 and to transmit the sound as sound information to the first control unit 11. The sound information is converted into a digital signal by an analog/digital converter contained in the first control unit 11. It is preferable to use as the microphone 5 a unidirectional microphone whose sensitivity is the highest in the forward direction of the microphone so as not to unnecessarily pick up noise from the road.

The GPS (Global Positioning System) sensor 6 receives from a plurality of GPS satellites radio signals carrying information such as the orbits of the satellites and time data generated by the atomic clocks mounted in the satellites, and obtains current position information and current time information by calculating the relative difference in distance to the respective satellites from the difference in arrival time of the radio signals. By acquiring radio signals from at least three satellites, the GPS sensor 6 can determine its position on the earth's surface. The GPS sensor 6 passes GPS information, including the thus detected current position information and current time information, to the first control unit 11.

The acceleration sensor 7 is constructed from a so-called G sensor (Gravity Accelerative Sensor) that detects the magnitude of an impact applied to the vehicle 1 as the magnitude of gravitational acceleration. The acceleration sensor 7 includes a semiconductor that, when subjected to an impact, produces a current proportional to the gravitational acceleration. The acceleration sensor 7 detects the magnitude of the gravitational acceleration in the longitudinal, as well as the transverse direction of the vehicle, and supplies gravitational acceleration information to the first control unit 11.

The vehicle speed sensor 8 is constructed from a magnetic sensor or optical sensor, and converts the rotation of the rotor mounted on the driveshaft of the vehicle 1 into a pulse signal for output to the first control unit 11. The first control unit 11 computes the speed of the vehicle 1 by calculating the number of revolutions of the driveshaft per unit time from the pulse signal received from the vehicle speed sensor 8.

The image capture switch 9, when operated by the user, transmits a signal to the first control unit 11 electrically connected to it. In response, the first control unit 11 performs control so that the image information, etc., stored in the semiconductor storage unit 12 are transferred for recording on the memory card 30. That is, the operation of the image capture switch 9 constitutes a recording condition. Provisions may be made to record on the memory card 30 only the image information captured at the moment the image capture switch 9 is operated.

The interface (I/F) 10 constitutes a slot provided in the drive recorder 2 for insertion of the memory card 30. The I/F 10 transfers the image information, etc. from the drive recorder 2 to the inserted memory card 30 for recording thereon.

The first radio communication unit 20 is configured to be able to transmit and receive data to and from a second radio communication unit 120 located at the base station 100. The first radio communication unit 20 receives data indicating the driving conditions of the vehicle 1 from the first control unit 11, transmits it to the second radio communication unit 120 at the base station 100, receives recording condition setting information from the second radio communication unit 120 at the base station 100, and passes it to the first control unit 11.

The memory card 30 is a recording medium removable from the drive recorder 2, and is constructed from a programmable nonvolatile semiconductor memory card such as an SD card (Secure Digital Memory Card), a CF card (Compact Flash Card), or a memory stick. The memory card 30 is used to record image information, sound information, etc.

In the present embodiment, an SD card is used as the removable memory card 30, but alternatively, use may be made of other types of removable memory card, a hard disk, or the like. As an alternative example, a hard disk may be built into the drive recorder 2 and used in place of the memory card 30, and the radio communication unit 20 may be configured to transmit the image information, sound information, etc., recorded on the hard disk, to the PC 110 located at the base station.

At the base station 100, there is provided a system comprising the PC 110 which is connected to the radio communication unit 120, output device 130, input device 140, and storage device 150 constructed from a memory such as a hard disk that stores map data, etc.

The PC 110 comprises a second control unit 111, which includes a CPU, a RAM, and a ROM, and an I/F 112. The I/F 112 constitutes a slot for insertion of the memory card 30. The image information, sound information, etc., recorded on the memory card 30 are transferred via the I/F 112 to the PC 110.

The second radio communication unit 120 is configured to be able to transmit and receive data to and from the first radio communication unit 20 provided in the vehicle 1. The second radio communication unit 120 receives the data indicating the driving conditions of the vehicle 1 from the first radio communication unit 20, passes it to the second control unit 111 in the PC 110, receives the recording condition setting information from the second control unit 111, and transmits it to the first radio communication unit 20.

The output device 130 comprises a liquid crystal display or the like, and is used to display in a suitable manner the image information, etc., recorded on the memory card 30.

The input device 140 comprises a keyboard, mouse, etc., and is used as a means for entering operation inputs to the PC 110 when the user operates the PC 110.

The storage device 150 is constructed from a recording medium such as a hard disk or DVD, and stores the map information and recording condition setting information to be described later as well as the image information, sound information, etc., transferred from the memory card 30.

Next, a procedure for recording the image information, sound information, etc., in the drive recorder 2 will be described.

The first control unit 11 acquires still image data from the video cameras 3 and 4 in an alternating fashion at a combined rate of 10 frames per second (i.e., still images from the video camera 3 and still images from the video camera 4 are respectively acquired at intervals of 0.2 second in an alternating fashion). At the same time, the first control unit 11 acquires sound information from the microphone 5. The first control unit 11 stores the thus acquired image information and sound information in a continuously looping fashion in the semiconductor storage unit 12. The intervals of time at which the first control unit 11 acquires the still image data and the number of still image frames to be acquired, described above, are only illustrative and not restrictive.

When the first control unit 11 detects the occurrence of the recording condition hereinafter described, a total of 20 seconds of image information, more specifically, 12 seconds before and 8 seconds after the occurrence of the recording condition (a total of 200 still images for each occurrence of the recording condition), is transferred together with the accompanying sound information from the semiconductor storage unit 12 to the memory card 30 for recording thereon. Since the image information, sound information, etc., recorded on the memory card 30 can be played back on the PC 110, the user of the drive recorder 2 can investigate the driving conditions of the vehicle 1 and events leading up to an accident. The length of time that the first control unit 11 records the information on the memory card 30 for each occurrence of the recording condition (that is, 12 seconds before and 8 seconds after the occurrence of the recording condition), described above, is only illustrative and not restrictive.

Next, a description will be given of how the recording condition holds.

In the drive recorder 2 according to the present invention, it is determined that the recording condition holds when any one of the following events occurs.

1. G detection: The acceleration sensor 7 has detected a gravitational acceleration not smaller than a predetermined threshold value. More specifically, the first control unit 11 detects every 10 milliseconds the sum of the absolute values of the gravitational accelerations measured from the outputs of the acceleration sensor 7, i.e., (Gx²+Gy²)^{0.5}, where Gy denotes the gravitational acceleration in the longitudinal direction of the vehicle 1 and Gx the gravitational acceleration in the transverse direction of the vehicle 1, and it is determined that the recording condition holds when the detected value is not smaller than the threshold value. The threshold value is initially set to 0.40 G.

2. Speed trigger: The rate of change of the speed of the vehicle 1 detected by the vehicle speed sensor 8 over a predetermined period of time has become equal to or exceeded a threshold value. The initial setting is such that, when the vehicle is traveling at a speed of 60 km/h or higher, if the rate of deceleration of the vehicle in one second has become equal to or exceeded the threshold value of 14 km/h, it is determined that the recording condition holds. The reason for such setting is that when the vehicle 1 has decelerated at such a rate, the situation can be determined as being the occurrence of an accident or the imminence of an accident.

3. Image capture SW: The image capture switch 9 is operated.

When the recording condition holds due to one of the above events, the first control unit 11 performs control so that a total of 20 seconds of image information, i.e., 12 seconds before and 8 seconds after the occurrence of the recording condition, is transferred together with the accompanying sound information from the semiconductor storage unit 12 to the memory card 30 for recording thereon. Further, when the recording condition holds, event data indicating the event that triggered the recording condition (i.e., data indicating one of the above three events) is also recorded on the memory card 30.

The threshold values for G detection and speed trigger are temporarily stored in the RAM of the first control unit 11. The first control unit 11, at predetermined intervals of time, compares the detection values from the acceleration sensor 7 and the vehicle speed sensor 8 with the temporarily stored threshold values to determine whether the recording condition due to G detection or speed trigger holds or not.

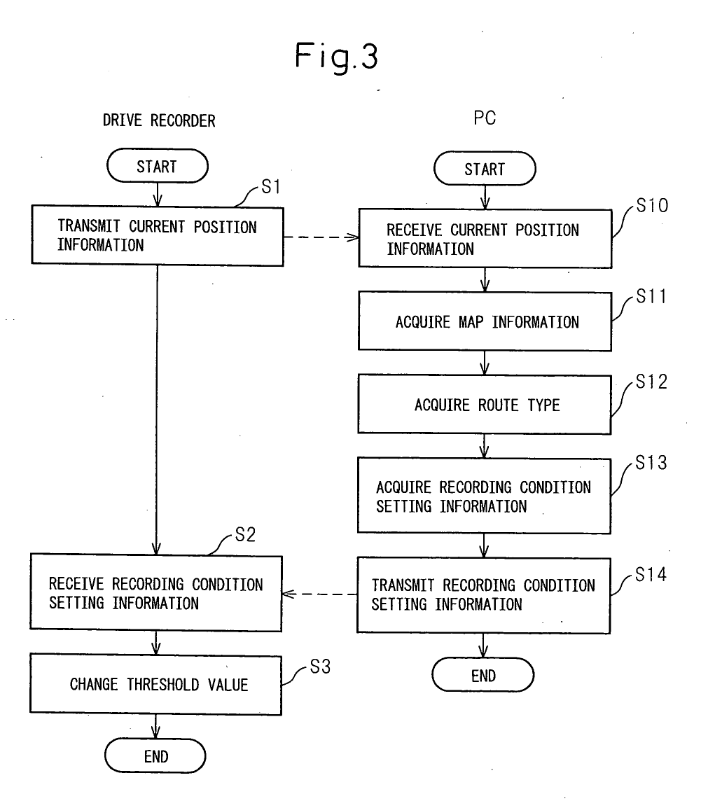

FIG. 3 is a diagram showing a process flow illustrating how the G-detection threshold value in the drive recorder 2 is changed.

The process flow shown in FIG. 3 illustrates one example of the sequence of operations in which the threshold value used in the drive recorder 2 is changed by the PC 110 located at the base station 100. It is assumed here that, prior to the initiation of the process flow shown in FIG. 3, power is turned on to the drive recorder 2 in the vehicle 1 and the various component elements connected to the drive recorder 2, thus setting them ready to operate, and also that power is turned on to the system at the base station 100, including the PC 110, thus setting the system ready to operate so that data communications can be performed between the vehicle 1 and the base station 100 via the respective radio communication units 20 and 120. The process flow shown in FIG. 3 is performed at the vehicle 1 side by the first control unit 11 in accordance with the program prestored in the control unit 11, and at the base station 100 by the second control unit 111 in accordance with the program prestored in the second control unit 111.

First, the first control unit 11 in the drive recorder 2 acquires the current position information of the vehicle 1 based on the data received from the GPS sensor 6, and transmits the current position information to the base station 100 by means of the first radio communication unit 20 (S1).

The second control unit 111 in the PC 110 receives the current position information by means of the second radio communication unit 120 (S10), and retrieves from the storage device 150 the map information corresponding to the received current position information (S11).

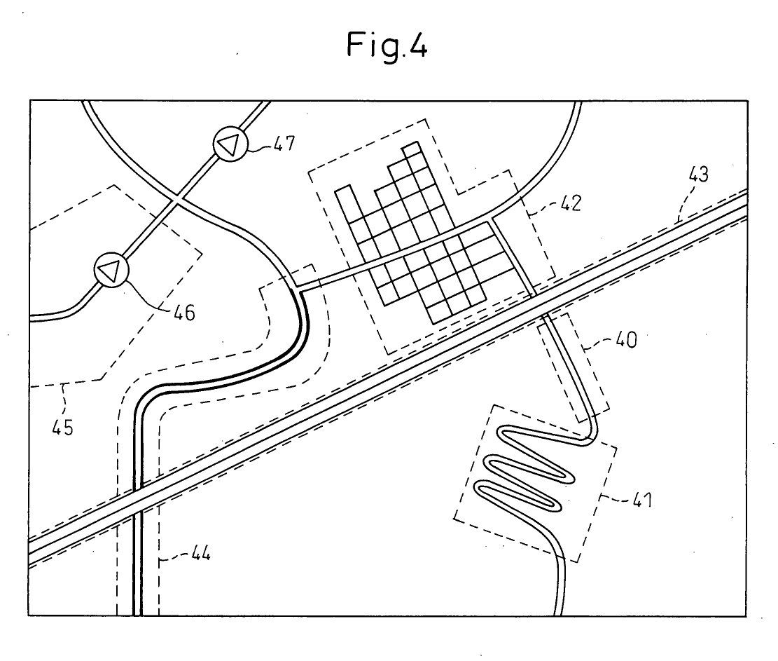

FIG. 4 is a diagram showing one example of a portion of the map information.

In the map information, a route type is assigned to each route shown on the map. In FIG. 4, route type 40 indicates a route with a steep slope, route type 41 indicates a route with a sharp curve, route type 42 indicates a city area, route type 43 indicates an expressway, route type 44 indicates that the route is congested, and route type 45 indicates a sightseeing area. Routes not marked with any route type are assumed to belong to the “general” route type. The PC 110 is configured to be able to acquire road congestion information via the second radio communication unit 120 or via the Internet not shown and to reflect the congestion information on the stored map information.

Next, based on the received current position information and the map information, the second control unit 111 in the PC 110 maps the current position of the vehicle 1 onto the map, and acquires the route type of the route along which the vehicle 1 is traveling (S12). In FIG. 4, if the vehicle 1 is currently located at the position indicated by mark 46, for example, the second control unit 111 in the PC 110 determines that the route type 45 (sightseeing area) corresponds to the current position of the vehicle 1. On the other hand, in FIG. 4, if the vehicle 1 is currently located at the position indicated by mark 47, the second control unit 111 in the PC 110 determines that the route type “general” corresponds to the current position of the vehicle 1.

Next, the second control unit 111 in the PC 110 acquires the recording condition setting information for G detection corresponding to the route type (S13).

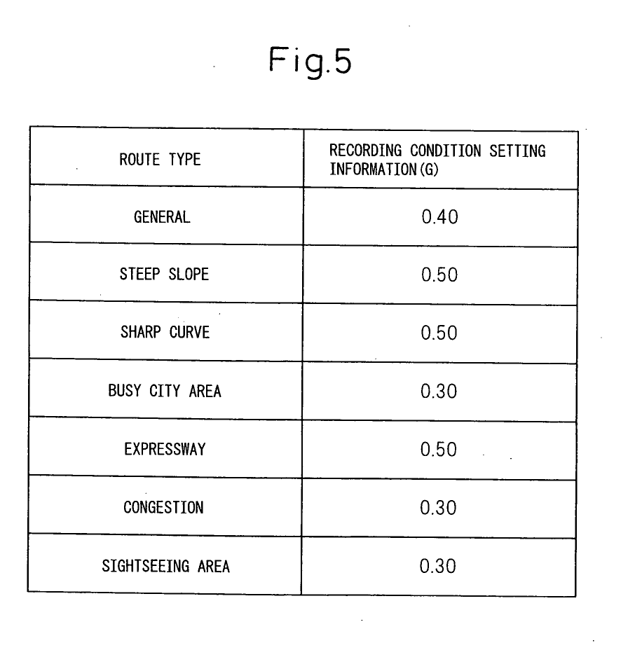

FIG. 5 is a diagram showing a table that provides a mapping of the route type to the recording condition setting information.

As previously noted, the standard threshold value for G detection used to determine the occurrence of the recording condition is 0.40 G. Accordingly, in the case of the “standard” route type, the recording condition setting information is 0.40 G. On the other hand, in the case of the route type 40 corresponding to a steep slope, the recording condition setting information is set higher than the standard threshold value, i.e., to 0.50 G, because the data output from the acceleration sensor 7 tends to become larger due to the steep slope. Likewise, in the case of the route type 41 corresponding to a sharp curve or in the case of the route type 43 corresponding to an expressway, the recording condition setting information is also set higher than the standard threshold value, i.e., to 0.50 G, because the vehicle tends to be subjected to a greater sideways G when traveling around a sharp curve or a greater G tends to be detected for the same amount of applied braking force when the vehicle is traveling at high speed.

On the other hand, in the case of the route type 42 corresponding to a busy city area or in the case of the route type 44 corresponding to a congested route or the route type 45 corresponding to a sightseeing area, the possibility cannot be ruled out that a smaller G may be detected in the event of the occurrence of an accident, since the vehicle runs at low speed in such areas. In view of this, the recording condition setting information corresponding to such areas is set lower than the standard threshold value, i.e., to 0.30 G.

Accordingly, in FIG. 4, if the vehicle 1 is currently located at the position indicated by mark 46, for example, the second control unit 111 in the PC 110 determines that the route type 45 corresponds to the current position of the vehicle 1, and 0.30 G is acquired as the recording condition setting information corresponding to the sightseeing area.

Next, the second control unit 111 in the PC 110 transmits the thus acquired recording condition setting information to the drive recorder via the second radio communication unit 120 (S14), and terminates the sequence of operations. In the PC 110, the sequence of operations from S10 to S14 in FIG. 3 is repeated at predetermined intervals of time or in response to the reception of the current position information from the drive recorder 2.

Next, when the recording condition setting information is received via the first radio communication unit 20 (S2), the first control unit 11 in the drive recorder 2 performs processing to replace the temporarily stored G-detection threshold value with the received recording condition setting information (S3), and terminates the sequence of operations. In the drive recorder 2, the sequence of operations from S1 to S3 in FIG. 3 is repeated at predetermined intervals of time (for example, every 10 seconds).

Since the appropriate G-detection threshold value corresponding to the route along which the vehicle 1 is traveling is set in accordance with the procedure of FIG. 3, as described above, the image information, etc., can always be recorded on the memory card 30 by an optimum condition.

The above example has shown the case where the routes are classified into seven types, including the “general” type, and the appropriate recording condition setting information is set for each route type. However, the route types are not limited to the above seven types, but may further include other types, or alternatively, only some of the seven types may be selected for use. For example, a route type accounting for the road conditions (such as a gravel road, an unpaved road, a bumpy road, etc.) may be added (in this case, the threshold value is set higher than the standard value, since G tends to be easily detected), or a route type accounting for the number of intersections or narrow roads in the vicinity may be added (in this case, the threshold value is set lower than the standard value, since the vehicle is expected to travel at low speed); further, a route type corresponding to, the route the user of the vehicle 1 mainly uses or is familiar with may be added (in this case, the threshold value is set lower than the standard value in order to prevent dangerous driving), or a route type corresponding to the route along which the vehicle 1 is expected to travel (for example, a bus route) may be added (in this case, the threshold value is set lower than the standard value in order to prevent dangerous driving).

The above example has shown the configuration in which the current position information of the vehicle 1 is transmitted from the drive recorder 2 to the PC 110 as the data indicating the driving conditions of the vehicle 1. However, as an alternative configuration, data concerning the carrying weight of the vehicle 1 may be transmitted from the drive recorder as the data indicating the driving conditions of the vehicle. In this case, the vehicle 1 must be equipped with a carrying weight sensor, and the drive recorder 2 must be configured to be able to receive data from the carrying weight sensor. For example, when the carrying weight is heavy, the PC 110 that received the data concerning the carrying weight can set the recording condition setting information for G detection lower than the standard value, since G tends to be easily detected in such cases, and can transmit it to the drive recorder 2 to set the recording condition threshold value for G detection.

As a further alternative configuration, the speed data of the vehicle 1 calculated based on the data supplied from the vehicle speed sensor 8, or data concerning the length of time the vehicle 1 has been continuously traveling, or data concerning the time segment (nighttime, daytime, etc.) in which the vehicle 1 is traveling, or data concerning the occupancy state (empty or occupied in the case of a taxi, or the presence or absence of a patient in the case of an ambulance) may be transmitted from the drive recorder as the data indicating the driving conditions of the vehicle. The PC 110 that received such data can set the recording condition threshold value for G detection by transmitting to the drive recorder 2 the recording condition setting information for G detection appropriate to the received data.

The above example has been described for the case where the G-detection threshold value in the drive recorder 2 is changed to an optimum value by the PC 110 from a remote location via radio communication. However, for the other case where the recording condition holds, i.e., for the speed trigger also, provisions may be made so that the PC 110 can change the threshold value from a remote location via radio communication in the same manner as described above, in accordance with the type of the route along which the vehicle 1 is traveling.

Further, the PC 110 may be configured to control the drive recorder 2 so that the length of time for acquisition of the image information or sound information (12 seconds before and 8 seconds after the occurrence of the recording condition) is changed based on the received data, or so that the way the video cameras are used to capture still images is changed based on the received data (for example, from the alternate use between the video cameras 3 and 4 to the use of the video camera 3 only), or so that the interval of time at which to capture the image information (one frame every 0.1 second) is changed based on, the received data.

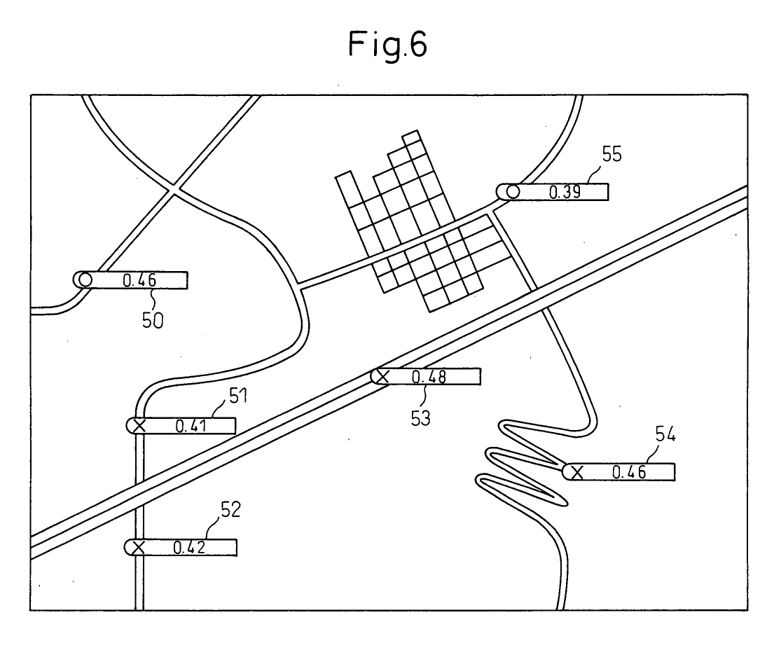

FIG. 6 is a diagram showing one example of a portion of another map information.

In FIG. 6, several pieces of history information 50 to 55 concerning the places where image information was recorded in the past by the drive recorder are displayed on the map. The history information judged worth recording as a result of the investigation by the PC is marked with an open circle, while the history information not judged worth recording is marked with a cross. Each piece of history information 50 to 55 also shows the G value detected at the time of the occurrence of the recording condition.

When many pieces of such history information have been acquired for a given route, for example, the lowest G value among the G values associated with the history information judged worth recording (marked with an open circle) may be recorded as the recording condition setting information for G detection appropriate to that route, and the PC 110 may set the G-detection threshold value by transmitting the recording condition setting information to the drive recorder 2 mounted in the vehicle 1 traveling along that route.

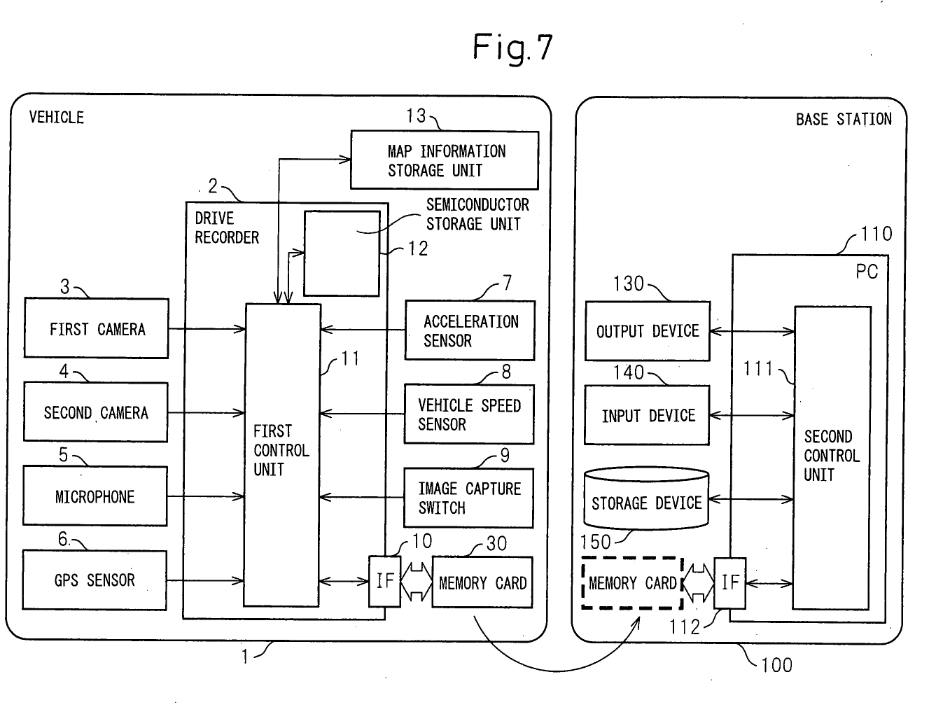

FIG. 7 is a diagram schematically showing the configuration of another system according to the present invention.

In FIG. 7, the same component elements as those in FIG. 2 are designated by the same reference numerals, and the description thereof will not be repeated here. The system of FIG. 7 differs from the system of FIG. 2 in that the first and second radio communication units 20 and 120 are omitted in the system of FIG. 7 and, instead, a map information recording unit 13 is provided in the vehicle 1.

The map information recording unit 13 is constructed from an HDD or the like, and stores the same information as the map information (for example, see FIG. 4) stored on the storage device 150. Further, in the system of FIG. 7, the GPS sensor 6, map information recording unit 13, etc., at the vehicle 1 side may be implemented by using the corresponding functions incorporated in the navigation system mounted in the vehicle.

In the system of FIG. 7, the first control unit 11 in the drive recorder 2 changes the G-detection threshold value in the drive recorder 2 by acquiring the current position information of the vehicle 1 from the GPS sensor 6, the map information corresponding to the current position information from the map information recording unit 13, and the route type corresponding to the route along which the vehicle 1 is traveling, and by determining from a mapping table, such as shown in FIG. 5, the recording condition setting information for G detection corresponding to the route type, and replacing the temporarily stored G-detection threshold value with the thus determined recording condition setting information. That is, in the system of FIG. 7, the recording condition setting information is determined at the vehicle 1 side, rather than transmitting the vehicle position information, etc., from the vehicle 1 to the base station 100 and receiving the recording condition setting information from the base station 100.

In the system of FIG. 7 also, since the appropriate G-detection threshold value is set, the image information, etc., can always be recorded on the memory card 30 by an optimum condition.

Further, in the system of FIG. 7 also, not only the vehicle current position information, but also the vehicle carrying-weight information, vehicle speed information, vehicle continuous traveling time information, vehicle traveling time-segment information, vehicle occupancy state information, or history information such as shown in FIG. 6, can be used as the vehicle driving condition information for determining the recording condition setting information.

What is claimed is:

1. An image recording condition setting apparatus comprising:
a receiving unit for receiving vehicle driving condition information from a drive recorder;
determining means for determining recording condition setting information based on said received vehicle driving condition information; and
a transmitting unit for transmitting said recording condition setting information, determined by said determining means, to said drive recorder.

2. The image recording condition setting apparatus according to claim 1, wherein said vehicle driving condition information is vehicle current position information, vehicle carrying-weight information, vehicle speed information, vehicle continuous traveling time information, vehicle traveling time-segment information, or vehicle occupancy state information.

3. The image recording condition setting apparatus according to claim 1, further comprising a storage unit for storing map information, including route type, and said recording condition setting information corresponding to said route type.

4. The image recording condition setting apparatus according to claim 1, wherein said recording condition setting information is used to set a threshold value for said drive recorder to record an image.

5. An image recording condition setting apparatus comprising:
a receiving unit for receiving vehicle position information from a drive recorder;
a storage unit for storing map information including route type;
determining means for acquiring, based on said position information and said map information, the route type of a route along which a vehicle is traveling, and for determining recording condition setting information corresponding to said route type; and
a transmitting unit for transmitting said recording condition setting information, determined by said determining means, to said drive recorder in order to set a threshold value for a condition for said drive recorder to record an image.

6. An image recording condition setting method for use in a setting apparatus capable of communicating with a drive recorder, the method comprising the steps of:
receiving vehicle driving condition information from said drive recorder;
determining recording condition setting information based on said received vehicle driving condition information; and
transmitting said determined recording condition setting information to said drive recorder in order to set a threshold value for a condition for said drive recorder to record an image.

7. An image recording condition setting method for use in a drive recorder connected so as to be able to communicate with a setting apparatus, the method comprising the steps of:
transmitting vehicle driving condition information to said setting apparatus;
receiving from said setting apparatus recording condition setting information associated with said vehicle driving condition information; and
setting said recording condition setting information as a threshold value for a condition for recording an image.

8. An image recording condition setting method for use in system constructed from a drive recorder and a setting apparatus capable of communicating with each other, the method comprising the steps of:
transmitting vehicle position information to said setting apparatus by said drive recorder;
receiving said position information by said setting apparatus;
determining recording condition setting information based on said position information by said setting apparatus;
transmitting said recording condition setting information to said drive recorder by said setting apparatus; and
setting said received recording condition setting information as a threshold value for a condition for said drive recorder to record an image by said drive recorder.

9. A drive recorder comprising:
an acquiring unit for acquiring vehicle driving condition information; and
a setting unit for setting recording condition setting information, determined based on said vehicle driving condition information, as a threshold value for a condition for recording an image.

10. The drive recorder according to claim 9, further comprising:
a transmitting unit for transmitting said vehicle driving condition information; and
a receiving unit for receiving said recording condition setting information determined based on said vehicle driving condition information.

11. The drive recorder according to claim 9, further comprising determining means for determining said recording condition setting information based on said vehicle driving condition information.

12. The drive recorder according to claim 9, wherein said vehicle driving condition information is Vehicle current position information, vehicle carrying-weight information, vehicle speed information, vehicle continuous traveling time information, vehicle traveling time-segment information, or vehicle occupancy state information.
